(19) United States
(12) Patent Application Publication
(10) Pub. No.: US 2014/0177535 A1
(43) Pub. Date: Jun. 26, 2014

(54) METHOD AND APPARATUS FOR ADMISSION CONTROL IN A WIRELESS COMMUNICATION SYSTEM

(71) Applicant: MOTOROLA SOLUTIONS, INC., Schaumburg, IL (US)

(72) Inventors: PAULA TJANDRA, INVERNESS, IL (US); STEPHEN S. GILBERT, LAKE ZURICH, IL (US)

(73) Assignee: MOTOROLA SOLUTIONS, INC., SCHAUMBURG, IL (US)

(21) Appl. No.: 13/723,792

(22) Filed: Dec. 21, 2012

(51) Int. Cl. H04W 72/10

(52) U.S. Cl. CPC H04W 72/10
USPC 370/329

(57) ABSTRACT

A method and network element are provided that perform admission control in a wireless communication system by, in response to receiving a new bearer request associated with a user equipment (UE), can free up bearers currently allocated to the UE when the UE's bearer limit is reached. In response to receiving a bearer request associated with the UE, the method and network element determines a number of bearers currently allocated to the UE, wherein the UE is limited to a maximum number of bearers, and when the UE currently is allocated its maximum number of bearers, determines a priority associated with the bearer request, compares the determined priority to a priority associated with each bearer currently allocated to UE to produce one or more comparisons, and based on the one or more comparisons, determining whether to preempt a currently allocated bearer to admit the requested bearer.

### FIELD OF THE INVENTION

The present invention relates generally to wireless communication systems, and, in particular, to a scheduling of bearers in a wireless communication system.

### BACKGROUND OF THE INVENTION

In a Third Generation Partnership Project (3GPP) Long Term Evolution (LTE) communication system, a user equipment (UE) is limited to having assigned a maximum of eight bearers at any given time. If the UE's bearer limit is reached, then subsequent bearer requests associated with the UE will be rejected, regardless of the priority of the request or the level of congestion of a network.

### BRIEF DESCRIPTION OF THE DRAWINGS

FIG. 1 is a block diagram of a wireless communication system in accordance with an embodiment of the present invention.

FIG. 2 is a block diagram of a user equipment of the communication system of FIG. 1 in accordance with an embodiment of the present invention.

FIG. 3 is a block diagram of an eNodeB of the communication system of FIG. 1 in accordance with an embodiment of the present invention.

FIG. 4 is a block diagram of a network gateway of the communication system of FIG. 1 in accordance with an embodiment of the present invention.

FIG. 5 is a signal flow diagram illustrating a method of admission control performed by the communication system of FIG. 1 in accordance with various embodiments of the present invention.

FIG. 6 is a signal flow diagram illustrating a method of admission control performed by the communication system of FIG. 1 in accordance with various other embodiments of the present invention.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need for a method and an apparatus reduces a likelihood that a high priority bearer request associated with a user equipment (UE) will be rejected when the UE's bearer limit has been reached, regardless of a priority of applications or services currently allocated bearers and a congestion level of the network, a method and network element are provided that perform admission control in a wireless communication system by, in response to receiving a new bearer request associated with the UE, freeing up bearers currently allocated to the UE. In response to receiving a bearer request associated with the UE, the method and network element determines a number of bearers currently allocated to the UE, wherein the UE is limited to a maximum number of bearers, and when the UE currently is allocated its maximum number of bearers, determines a priority associated with the bearer request, compares the determined priority to a priority associated with each bearer currently allocated to UE to produce one or more comparisons, and based on the one or more comparisons, determining whether to preempt a currently allocated bearer to admit the requested bearer.

Generally, an embodiment of the present invention encompasses a method for admission control in an Orthogonal Frequency Division Multiplexing (OFDM) communication system. The method includes receiving a bearer request associated with a user equipment (UE) and determining a number of bearers currently allocated to the UE, wherein the UE is limited to a maximum number of bearers. The method further includes, when the UE currently is allocated its maximum number of bearers, determining a priority associated with the bearer request, comparing the determined priority to a priority associated with each bearer currently allocated to UE to produce one or more comparisons, and based on the one or more comparisons, determining whether to preempt a currently allocated bearer to admit the requested bearer.

Another embodiment of the present invention encompasses a network element operable in an OFDM communication system. The network element includes a processor that is configured to receive a bearer request associated with a user equipment (UE) and determine a number of bearers currently allocated to the UE, wherein the UE is limited to a maximum number of bearers. The processor further is configured to, when the UE currently is allocated its maximum number of bearers, determine a priority associated with the bearer request, compare the determined priority to a priority associated with each bearer currently allocated to UE to produce one or more comparisons, and based on the one or more comparisons, determine whether to preempt a currently allocated bearer to admit the requested bearer.

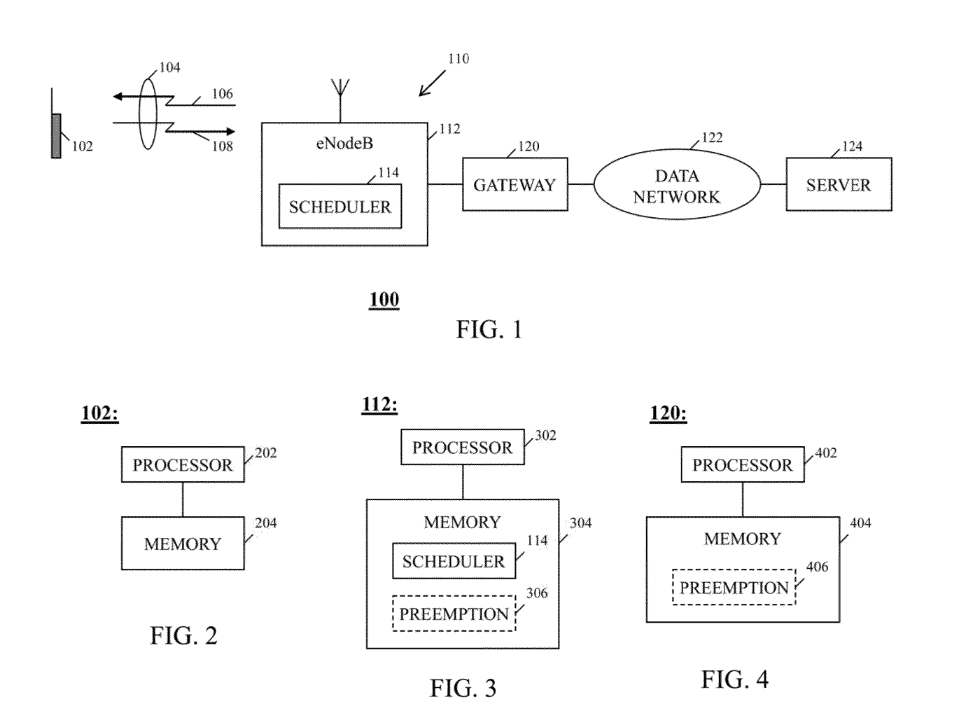

The present invention may be more fully described with reference to FIGS. 1-6. FIG. 1 is a block diagram of a wireless communication system 100 in accordance with an embodiment of the present invention. Communication system 100 includes a user equipment (UE) 102, such as but not limited to a cellular telephone, a radio telephone, a personal digital assistant (PDA), laptop computer, or personal computer with radio frequency (RF) capabilities, or a wireless modem that provides RF access to digital terminal equipment (DTE) such as a laptop computer. In various technologies, UE 102 may be referred to as a mobile station (MS), user terminal (UT), subscriber station (SS), subscriber unit (SU), remote unit (RU), access terminal, and so on.

Communication system 100 further includes an access network 110 in communication with a network gateway 120. Network gateway 120 is in communication with a server 124 via an intervening data network 122, such as the Internet or any other public or private data network. Network gateway 120 is a packet data gateway that routes and forwards data packets and may comprise, for example, one or more of a Packet Data Gateway (PDG), a Serving Gateway (SGW), and a Packet Data Network Gateway (PGW).

Access network 110 includes a wireless access node 112 that provides wireless communication services to each UE, such as UE 102, residing in a coverage area of the access node via a corresponding air interface 104. Preferably, wireless access node 112 is an eNodeB (and is referred to herein as eNodeB 112); however, wireless access node 112 may be any network-based wireless access node, such as an access point (AP) or base station (BS). Air interface 104 comprises a downlink 106 and an uplink 108, wherein each of downlink 106 and uplink 208 comprises multiple communication channels, including multiple control channels and multiple bearer channels. Access network 110 also may include an access network controller (not shown), such as a Radio Network Controller (RNC) or a Base Station Controller (BSC), coupled to the eNodeB; however, in various embodiments of the present invention, the functionality of such an access network controller may be implemented in the access node, that is, the eNodeB.

Access network 110 further includes a scheduler 114. While FIG. 1 depicts scheduler 114 being implemented by eNodeB 112, in various other embodiments of the present invention scheduler 114 may be implemented in a separate network element accessible by the eNodeB 112 (for example, an access network controller (not shown) if included in the communication system). Together, each of eNodeB 112, gateway 120, data network 122, and server 124 may be referred to as a network of communication system 100 and, correspondingly, each of eNodeB 112, gateway 120, and server 124 may be referred to as a network element.

Referring now to FIGS. 2-4, block diagrams are provided of UE 102, eNodeB 112, and gateway 120 in accordance with an embodiment of the present invention. Each of UE 102, eNodeB 112, and gateway 120 includes a respective processor 202, 302, and 402, such as one or more microprocessors, microcontrollers, digital signal processors (DSPs), combinations thereof or such other devices known to those having ordinary skill in the art. The particular operations/functions of processors 202, 302, and 402, and thus of UE 102, eNodeB 112, and gateway 120, is determined by an execution of software instructions and routines that are stored in a respective at least one memory device 204, 304, and 404 associated with the processor, such as random access memory (RAM), dynamic random access memory (DRAM), and/or read only memory (ROM) or equivalents thereof, that store data and programs that may be executed by the corresponding processor. eNodeB 112 further implements scheduler 114 based on data and instructions maintained in the respective at least one memory device 304 and executed by processor 302 of the eNodeB.

In various embodiments of the present invention, one or more of eNodeB 112 and gateway 120 further may implement a per-user preemption function 306, 406 based on data and instructions maintained in the respective at least one memory device 304, 404 of the eNodeB, and gateway and executed by the respective processor 302, 402 of the eNodeB, and gateway. Generally, the per-user preemption function operates as follows. In response to receiving a bearer request associated with a UE, such as UE 102, the per-user preemption function, for example, per-user preemption functions 306 and 406, determines a number of bearers, such as Guaranteed Bit Rate (GBR) bearers and non-GBR bearers, currently allocated to the UE and whether the UE's bearer limit is reached, that is, whether the UE currently is allocated its maximum possible number of bearers (for example, eight in a 3GPP LTE system). When the per-user preemption function determines that the UE's bearer limit is reached, this triggers a determination, by the per-user preemption function, of a priority associated with the bearer request and a comparison of the determined priority to a priority associated with each of one or more bearers currently allocated to the UE, thereby producing one or more comparisons. Based on the one or more comparisons, the per-user preemption function then determines whether to preempt a lower priority bearer to admit the currently requested bearer. When the UE currently is assigned multiple bearers that are each associated with a priority that is lower than a priority associated with the bearer request, preferably the per-user preemption function determines to preempt a lowest priority bearer of the multiple bearers.

The embodiments of the present invention preferably are implemented within MS 102, eNodeB 112, and gateway 120, and more particularly with or in software programs and instructions stored in the respective at least one memory device 204, 304, and 404, and executed by respective processors 202, 302, and 402, associated with the of the MS, eNodeB, scheduler, and gateway. However, one of ordinary skill in the art realizes that the embodiments of the present invention alternatively may be implemented in hardware, for example, integrated circuits (ICs), application specific integrated circuits (ASICs), and the like, such as ASICs implemented in one or more of MS 102, eNodeB 112, and gateway 120. Based on the present disclosure, one skilled in the art will be readily capable of producing and implementing such software and/or hardware without undo experimentation.

Communication system 100 comprises a wideband packet data communication system that employs an Orthogonal Frequency Division Multiplexing (OFDM) modulation scheme for transmitting data over air interface 104. Preferably, communication system 100 is an Orthogonal Frequency Division Multiple Access (OFDMA) communication system, wherein a frequency bandwidth employed by the communication system is split into multiple frequency sub-bands, or Resource Blocks (RBs), during a given time period. Each sub-band comprises multiple orthogonal frequency sub-carriers over a given number of OFDM symbols, that are the physical layer channels over which traffic and signaling channels are transmitted in a TDM or TDM/FDM fashion. The channel bandwidth also may be sub-divided into one or more sub-band groups, or Resource Block Groups (RBGs), wherein each sub-band group comprises one or more sub-bands that may or may not be contiguous, and the sub-band groups may or may not be of equal size. A communication session may be assigned a bearer, that is, one or more sub-bands or sub-band groups, for an exchange of bearer information, thereby permitting multiple users to transmit simultaneously on the different sub-bands such that each user's transmission is orthogonal to the other users' transmissions.

In addition, communication system 100 preferably comprises a Third Generation Partnership Project (3GPP) Long Term Evolution (LTE) communication system. However, those who are of ordinary skill in the art realize that communication system 100 may operate in accordance with any wireless telecommunication system employing an OFDM modulation scheme and wherein a UE, a UE, such as UE 102, engaging in a communication session is limited to allocation of a pre-determined maximum of number of radio bearers at any given time. In the prior art, when the UE's bearer limit is reached, then subsequent bearer requests associated with the UE will be rejected, regardless of the priority of the request or the level of congestion of a network. One result of such a system is that if a bearer request is received for a new, higher priority service or application involving the UE (higher than the services or applications associated with the bearers currently assigned to the UE), and the UE has already reached it radio bearer limit, the bearer request will be rejected. In order to permit the establishment of such a higher priority service or application even when a UE has reached it radio bearer limit, communication system 100 provides an admission control algorithm that may preempt a UE's lower priority bearers/services/applications when a request for a higher priority bearer is received for the UE.

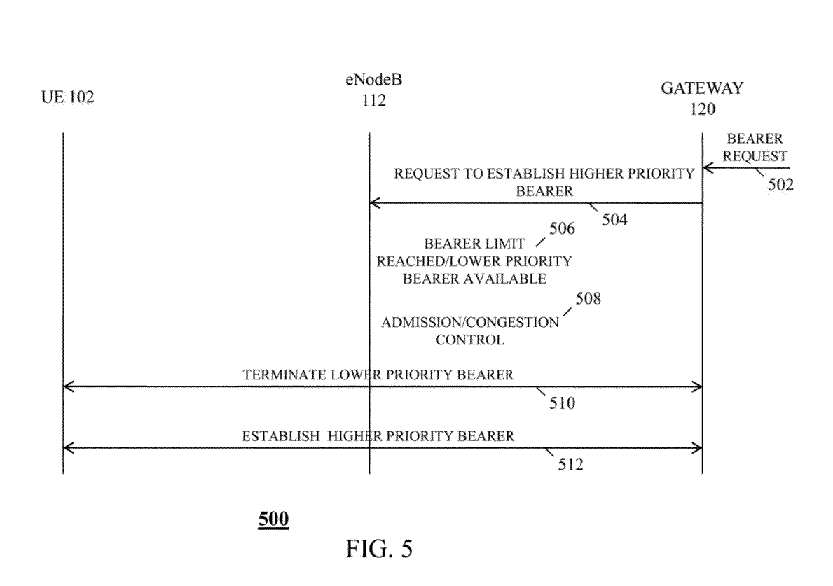

Referring now to FIG. 5, a signal flow diagram 500 is provided that illustrates a method of admission control performed by communication system 100 in accordance with various embodiments of the present invention, wherein the per-user preemption function is executed at eNodeB 112. Signal flow diagram 500 begins when gateway 120 receives a Guaranteed Bit Rate (GBR) bearer request 502 associated with UE 102, for example, from an application executed by server 124 and via an intervening Policy Control and Charging Rules Function (PCRF) (not shown).

The bearer request may include, for example, identifiers of the source/target UE 102/application associated with the request, bearer-type information, and an indication of a priority associated with the request. However, if not already included in bearer request 502, gateway 120 may determine, and add to the bearer request, the indication of the priority associated with the bearer request, for example, a priority of an application or service associated with the bearer request or one or more bearer parameters associated with the bearer request, such as Quality of Service (QoS) parameters, for example, Allocation and Retention Priority (ARP), Guaranteed Bit Rate (GBR) v. non-GBR, Maximum Bit Rate (MBR), and QoS Class Identifier (QCI), associated with the requested bearer.

In response to receiving bearer request 502, gateway 120 conveys a bearer request 504 to eNodeB 112 that includes the priority associated with the request. In various embodiments of the present invention, gateway 120 may forward received bearer request 502 or may generate and convey a new bearer request based on received bearer request 502. In response to receiving bearer request 504, eNodeB 112 executes 506 per-user preemption function 306 and, in association with scheduler 114, executes 508 an admission control algorithm.

More particularly, in executing the per-user preemption function 306, eNodeB 112 determines 506 a number of bearers, such as Guaranteed Bit Rate (GBR) bearers and non-GBR bearers, currently allocated to target UE 102. When the UE's bearer limit has been reached, that is, when the UE currently is allocated its maximum possible number of bearers, eNodeB 112, that is, per-user preemption function 306, determines 506 a priority associated with the requested bearer and compares the determined priority to a priority associated with each bearer currently allocated to UE 102 to produce one or more comparisons. Based on the one or more comparisons, per-user preemption function 306 determines 506 whether to preempt a lower priority bearer to admit the currently requested bearer. Such preemption of the lower priority bearer may occur even though the air interface associated with the preempted bearer is not congested, as the UE, when allocated its maximum possible number of bearers, cannot be allocated further bearers regardless of a congestion of an air interface associated with the preempted bearer.

When the UE's bearer limit has not yet been reached, that is, the UE currently is allocated fewer than its maximum possible number of bearers, eNodeB 112, that is, per-user preemption function 306, routes received bearer request 504 to scheduler 114 and the scheduler allocates 508 one or more bearers to the received bearer request and notifies UE 102 of the allocated bearer(s). In response to being allocated a bearer, UE 102 and gateway establish 512 an SDF via the allocated bearer.

When the UE's bearer limit has been reached, that is, the UE currently is allocated its maximum possible number of bearers, but none of the already allocated bearers is associated with a lower priority than the priority associated with the received bearer request, per-user preemption function 306 may route bearer request 504 to scheduler 114. In response to receiving bearer request 504, scheduler 114 rejects 508 the received bearer request, as the UE currently is at its bearer limit. However, in another embodiment of the present invention, eNodeB 112, and in particular per-user preemption function 306, may just drop bearer request 504. In response to receiving bearer request 504, scheduler 114 may reject 508 the received bearer request. Further, eNodeB 112, and in particular scheduler 114, may notify server 124 of the rejection, for example, by conveying a negative acknowledgement (NACK) of bearer request 502/504 to the server.

When the UE's bearer limit has been reached and one or more of the already allocated bearers is associated with a lower priority than the priority associated with the received bearer request, eNodeB 112, that is, per-user preemption function 306, preempts 508 a lower priority bearer in order to admit the currently requested bearer. That is, per-user preemption function 306 terminates 510 the lower priority bearer in order to free up a bearer for the received bearer request. For example, eNodeB 112, that is, per-user preemption function 306, may notify UE 102 and gateway 120 of the termination of the lower priority bearer, in response to which the UE and gateway terminate the bearer. Per-user preemption function 306 then routes bearer request 504 to scheduler 114, and the scheduler allocates 508 the terminated bearer to the received bearer request and notifies 508 each of UE 102 and gateway 120 that a bearer has been allocated. In response to being allocated a bearer, UE 102 and gateway establish 512 an SDF via the allocated bearer.

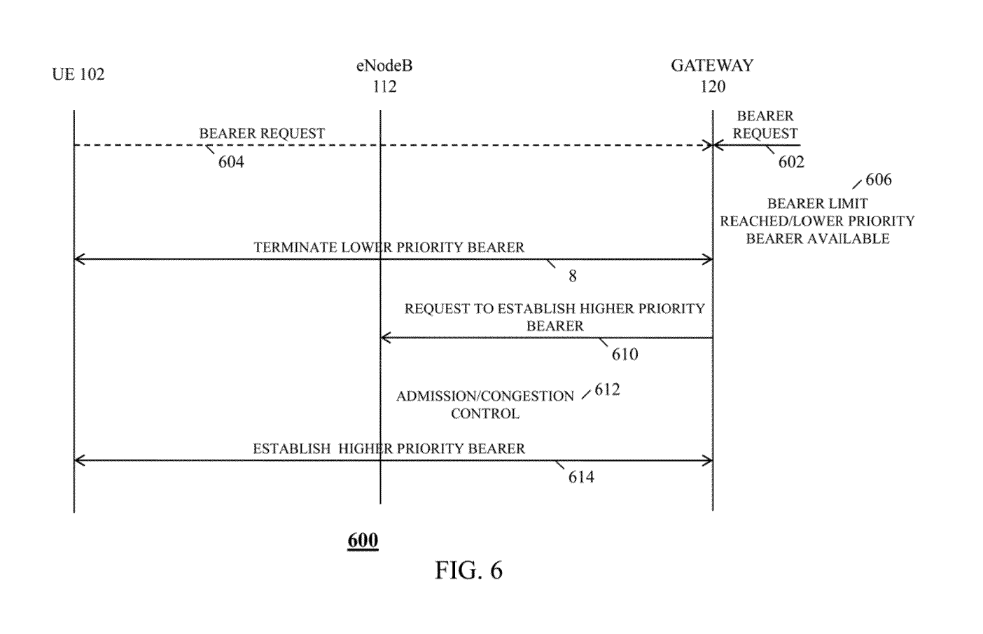

Referring now to FIG. 6, a signal flow diagram 600 is provided that illustrates a method of admission control performed by communication system 100 in accordance with various other embodiments of the present invention, where the per-user preemption function is executed by gateway 120. Signal flow diagram 600 begins when gateway 120 receives a Guaranteed Bit Rate (GBR) bearer request 602 associated with UE 102, for example, from an application executed by server 124 and via an intervening Policy Control and Charging Rules Function (PCRF) (not shown). In another embodiment of the present invention, gateway 120 may receive the Guaranteed Bit Rate (GBR) bearer request, that is, bearer request 604, from UE 102.

The bearer request may include, for example, identifiers of the source/target UE 102/application associated with the request, bearer-type information, and an indication of a priority associated with the request. However, if not already included in bearer request 502, gateway 120 may determine, and add to the bearer request, the indication of the priority associated with the bearer request, for example, a priority of an application or service associated with the bearer request or one or more bearer parameters associated with the bearer request, such as Quality of Service (QoS) parameters, for example, Allocation and Retention Priority (ARP), Guaranteed Bit Rate (GBR) v. non-GBR, Maximum Bit Rate (MBR), and QoS Class Identifier (QCI), associated with the requested bearer.

Further, in response to receiving bearer request 502, gateway 120 executes 606 per-user preemption function 406. More particularly, gateway 120, that is, per-user preemption function 406, determines 606 a number of bearers, such as Guaranteed Bit Rate (GBR) bearers and non-GBR bearers, currently allocated to target UE 102. When the UE's bearer limit has been reached, per-user preemption function 406 determines 606 a priority associated with the requested bearer and compares the determined priority to a priority associated with each bearer currently allocated to UE 102 to produce one or more comparisons. Based on the one or more comparisons, per-user preemption function 406 determines 606 whether to preempt a lower priority bearer to admit the currently requested bearer. Again, as noted above, such preemption of the lower priority bearer may occur even though the air interface associated with the preempted bearer is not congested, as the UE, when allocated its maximum possible number of bearers, cannot be allocated further bearers regardless of a congestion of an air interface associated with the preempted bearer.

When the UE's bearer limit has not yet been reached, that is, the UE currently is allocated fewer than its maximum possible number of bearers, gateway 120 conveys a bearer request 610 to eNodeB 112. In various embodiments of the present invention, gateway 120 may forward received bearer request 602 or may generate and convey a new bearer request based on received bearer request 602. In response to receiving bearer request 610, eNodeB 112, and in particular scheduler 114, allocates 614 one or more bearers to received bearer request 610 and notifies UE 102 of the allocated bearer(s). In response to being allocated a bearer, UE 102 and gateway establish 614 an SDF via the allocated bearer.

When the UE's bearer limit has been reached, that is, the UE currently is allocated its maximum possible number of bearers, but none of the already allocated bearers is associated with a lower priority than the priority associated with received bearer request 610, gateway 120, and in particular per-user preemption function 406, may convey a bearer request 610 to eNodeB 112. In various embodiments of the present invention, gateway 120 may forward received bearer request 602 or may generate and convey a new bearer request based on received bearer request 602. However, in another embodiment of the present invention, gateway 120, and in particular per-user preemption function 406, may just drop bearer request 602. In response to receiving bearer request 610, eNodeB 112, and in particular scheduler 114, may reject 510 the received bearer request, as the UE currently is at its bearer limit. Further, eNodeB 112, and in particular scheduler 114, may notify server 124 of the rejection, for example, by conveying a negative acknowledgement (NACK) of bearer request 602/610 to the server.

When a bearer limit has already been reached with respect to UE 102 and one or more of the already allocated bearers is associated with a lower priority than the priority associated with the received bearer request, per-user preemption function 406 of gateway 120 preempts 606 a lower priority bearer in order to admit the currently requested bearer. That is, gateway 120, and in particular per-user preemption function 406, terminates 608 the lower priority bearer to free up a bearer for the received bearer request. Gateway 120 then conveys a bearer request 610 to eNodeB 112, for example, forwards received bearer request 602 or generates and conveys a new bearer request based on received bearer request 602. In response to receiving bearer request 610, eNodeB 112, and in particular scheduler 114, allocates 612 the terminated bearer to the received bearer request and notifies 612 UE 102 of the allocated bearer(s). In response to being allocated a bearer, UE 102 and gateway 120 establish 614 an SDF via the allocated bearer.

By implementing a per-user preemption function that, in response to receiving a new bearer request associated with a UE, can free up bearers currently allocated to the UE when the UE's bearer limit is reached, communication system 100 better assures that provision of higher priority services or applications by, or to, the UE, such as emergency responder services, will not be blocked by lower priority services or applications currently being provided by, or to, the UE, which blocking can otherwise occur even when the system is not congested.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for admission control in an Orthogonal Frequency Division Multiplexing communication system, the method comprising:
receiving a bearer request associated with a user equipment (UE);
determining a number of bearers currently allocated to the UE, wherein the UE is limited to a maximum number of bearers;
when the UE currently is allocated its maximum number of bearers:
determining a priority associated with the bearer request;
comparing the determined priority to a priority associated with each bearer currently allocated to UE to produce one or more comparisons; and
based on the one or more comparisons, determining whether to preempt a currently allocated bearer to admit the requested bearer.

2. The method of claim 1, further comprising when the user equipment currently is allocated fewer than its maximum number of bearers, allocating a bearer to the bearer request.

3. The method of claim 1, wherein determining whether to preempt a currently allocated bearer comprises determining to preempt a bearer associated with a lower priority than the priority associated with the bearer request.

4. The method of claim 3, wherein the bearer associated with the lower priority is preempted even though the air interface associated with the preempted bearer is not congested.

5. The method of claim 3, wherein comparing the determined priority to a priority associated with each bearer currently allocated to UE to produce one or more comparisons comprises determining that a plurality of bearers currently allocated to the user equipment are associated with a lower priority than the priority associated with the bearer request and wherein determining to preempt a bearer associated with a lower priority than the priority associated with the bearer request comprises determining to preempt the bearer of the plurality of bearers associated with a lowest priority.

6. The method of claim 1, wherein determining whether to preempt a currently allocated bearer comprises:
determining that no currently allocated bearer has a lower priority than the priority associated with the bearer request; and
dropping the bearer request without conveying an associated bearer request to a scheduler.

7. The method of claim 1, wherein determining whether to preempt a currently allocated bearer comprises determining to preempt a currently allocated bearer and wherein the method further comprises:
terminating the currently allocated bearer; and
allocating the terminated bearer to the received bearer request.

8. The method of claim 1, wherein the priority associated with the bearer request comprises one or more of a priority of an application associated with the bearer request, a priority of a service associated with the bearer request, and Quality of Service (QoS) parameters.

9. A network element operable in an Orthogonal Frequency Division Multiplexing communication system, the network element comprising:
a processor that is configured to
receive a bearer request associated with a user equipment (UE);
determine a number of bearers currently allocated to the UE, wherein the UE is limited to a maximum number of bearers;
when the UE currently is allocated its maximum number of bearers:
determine a priority associated with the bearer request;
compare the determined priority to a priority associated with each bearer currently allocated to UE to produce one or more comparisons; and
based on the one or more comparisons, determine whether to preempt a currently allocated bearer to admit the requested bearer.

10. The network element of claim 9, wherein the processor is configured to, when the user equipment currently is allocated fewer than its maximum number of bearers, allocate a bearer to the bearer request.

11. The network element of claim 9, wherein the processor is configured to determine whether to preempt a currently allocated bearer by determining to preempt a bearer associated with a lower priority than the priority associated with the bearer request.

12. The network element of claim 11, wherein the bearer associated with the lower priority is preempted even though the air interface associated with the preempted bearer is not congested.

13. The network element of claim 11, wherein the processor is configured to compare the determined priority to a priority associated with each bearer currently allocated to UE to produce one or more comparisons by determining that a plurality of bearers currently allocated to the user equipment are associated with a lower priority than the priority associated with the bearer request, and wherein the processor is configured to determine to preempt a bearer associated with a lower priority than the priority associated with the bearer request by determining to preempt the bearer of the plurality of bearers associated with a lowest priority.

14. The network element of claim 9, wherein the processor is configured to determine whether to preempt a currently allocated bearer by:
determining that no currently allocated bearer has a lower priority than the priority associated with the bearer request; and
dropping the bearer request without conveying an associated bearer request to a scheduler.

15. The network element of claim 9, wherein the processor is configured to determine whether to preempt a currently allocated bearer by determining to preempt a currently allocated bearer and wherein the processor further is configured to terminate the currently allocated bearer.

16. The network element of claim 9, wherein the priority associated with the bearer request comprises one or more of a priority of an application associated with the bearer request, a priority of a service associated with the bearer request, and Quality of Service (QoS) parameters.

17. The network element of claim 9, wherein the network element is an eNodeB.

18. The network element of claim 9, wherein the network element is a gateway.
